(19) United States
(12) Patent Application Publication
(10) Pub. No.: US 2019/0138972 A1
(43) Pub. Date: May 9, 2019

(54) WEARABLE DEVICE FOR MONITORING WORK-RELATED CONDITIONS

(71) Applicant: John Robert Reid, Troy, MI (US)

(72) Inventor: John Robert Reid, Troy, MI (US)

(21) Appl. No.: 16/186,356

(22) Filed: Nov. 9, 2018

Related U.S. Application Data
(60) Provisional application No. 62/584,050, filed on Nov. 9, 2017.

(51) Int. Cl. G06Q 10/06

(52) U.S. Cl. CPC G06Q 10/06393

(57) ABSTRACT

A system for gathering and displaying data related to a wearer's performance and satisfaction in performing a job includes a wearable device to be worn by the wearer while performing the job. The wearable device includes sensors and is configured to collect and store data elements with values pertaining to one or more conditions associated with the ambient environment and/or the wearer. The wearable device also includes input and output devices to collect feedback data element regarding the wearer's job satisfaction. A server stores and analyzes the data elements to determine a job satisfaction score for the wearer and a correlation score that indicates a correlation between the job satisfaction values and one or more data elements pertaining to the ambient environment and/or the wearer. A reporting interface reports the job satisfaction and the correlation scores. A control interface allows an administrator to control settings related to operation of the system.

### CROSS REFERENCE TO RELATED APPLICATION

This U.S. utility patent application claims the benefit of U.S. provisional patent application No. 62/584,050 filed Nov. 9, 2017, the contents of which are incorporated herein by reference in its entirety.

### FIELD

The present disclosure relates generally to wearable devices to monitor and display data related to physical conditions and work satisfaction of the wearer.

### BACKGROUND

Job satisfaction plays an important role in management of any business that depends on workers, such as employees or independent contractors, to perform a job. Job satisfaction has significant correlation to worker productivity, to turn-over rate, and to the length of time that any given worker will continue to work at a particular job.

Measuring job satisfaction is traditionally a tedious process, involving regular surveys of workers, for example, during a periodic review. Obtaining an accurate and unbiased measurement of job satisfaction is traditionally very difficult. Furthermore, it is traditionally difficult for business management to identify and to quantify factors that impact job satisfaction.

### SUMMARY

A system for gathering and displaying data related to a wearer's satisfaction in performing a job is provided. The system includes a wearable device to be worn by the wearer while performing the job. The wearable device includes a sensor configured to measure an associated condition. The wearable device is configured to store a plurality of data elements, with each of the data elements containing a value associated with the associated condition at a given time.

Each of the data elements is one of an environmental data element with the corresponding value being associated with an environmental condition, or a user data element with the corresponding value being associated with a user condition, or a feedback data element with the corresponding value being associated with the wearer's job satisfaction.

The wearable device includes an output device configured to present a prompt to the wearer requesting specific information from the wearer. The wearable device also includes an input device configured to receive the value regarding the wearer's job satisfaction. The wearable device also includes a first communications interface configured to transmit the data elements to a server, which is configured to store and analyze the data elements and to determine a job satisfaction score, which is based upon the feedback data elements, or a correlation score indicating a degree of correlation between the feedback data elements and one or more of the environmental data elements and/or the user data elements.

The system also includes a reporting interface in communication with the server and configured to report the job satisfaction score or the correlation score.

A method of gathering and displaying data related to a wearer's satisfaction in performing a job is also provided. The method includes the steps of: measuring a value of an associated condition by a sensor in a wearable device worn by the wearer while performing the job; storing the value of the associated condition measured by the sensor as one of an environmental data element or a user data element; presenting a prompt to the wearer to request information from the wearer regarding job satisfaction; and receiving, by an input device, information regarding the wearer's job satisfaction, and storing the information regarding the wearer's job satisfaction as one or more feedback data elements. The method also includes: transmitting the feedback data element and one or more of the environmental data element or the user data element from the wearable device to a server; analyzing the data elements to determine one of a job satisfaction score or a correlation score for the wearer; and reporting the job satisfaction score or the correlation score by a reporting interface.

### BRIEF DESCRIPTION OF THE DRAWINGS

Further details, features and advantages of designs of the invention result from the following description of embodiment examples in reference to the associated drawings.

FIG. 1 is a block diagram view of a system of the present disclosure;

FIG. 2 is another block diagram of components in a system of the present disclosure;

FIG. 3 is a graphic representation of an example wearable device presenting an example user interface; and

FIG. 4A is a flow chart listing steps in a method for gathering and displaying data related to a wearer's satisfaction in performing a job; and

FIG. 4B is a continuation of the flow chart of FIG. 4A.

### DETAILED DESCRIPTION

Recurring features are marked with identical reference numerals in the figures, in which an example embodiment of a system 10 for gathering and displaying data related to a wearer's performance and satisfaction in performing a job is disclosed.

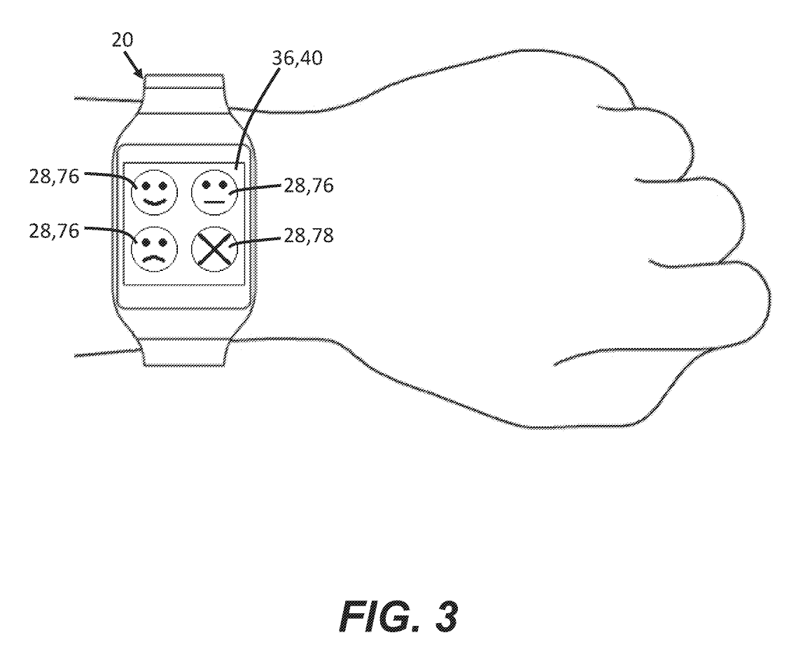

The system 10 includes a wearable device 20 to be worn by the wearer while performing a job. The wearable device 20 may take the form of a wristwatch as shown in FIG. 3. However, it should be appreciated that the wearable device 20 may take another form including, for example, a badge that is clipped or pinned to the wearer's clothing. The wearable device 20 may also be disposed upon or within a piece of equipment worn by the wearer while performing their job, such as a helmet, safety glasses, or outerwear, such as a parka or a reflective vest.

The wearable device 20 is configured to collect and store data elements 24, 26, 28 with values pertaining to one or more conditions associated with the ambient environment and/or the wearer.

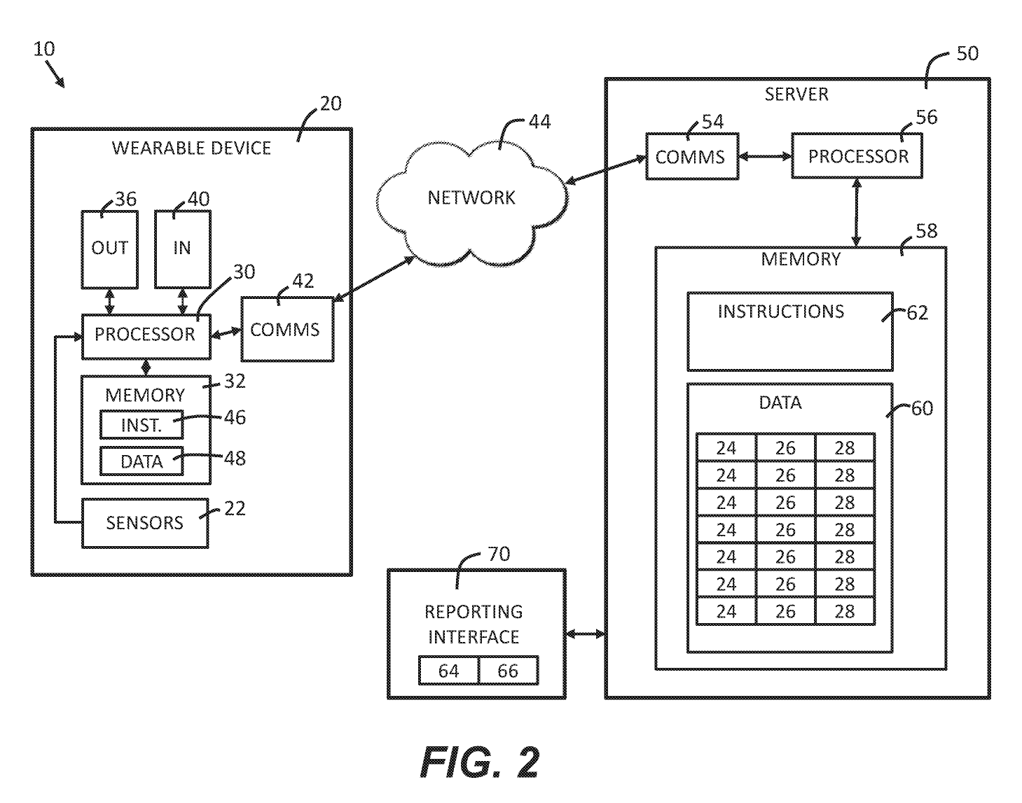

As shown in the block diagram of FIG. 2, the wearable device 20 includes a plurality of sensors 22, with each of the sensors 22 configured to measure a condition associated with the ambient environment and/or the wearer. For example, the sensor 22 may be a thermometer that is configured to measure the ambient temperature or the body temperature of the wearer. The wearable device 20 is configured to store the plurality of data elements 24, 26, 28, each containing a value associated with the associated condition at a given time. Each of the data elements 24, 26, 28 may include raw or scaled data regarding the condition measured. Each of the data elements 24, 26, 28 may also include time and/or date information of when the condition was measured, and/or an identification information describing the type of information, such as the condition or conditions associated with the data stored in the data element 24, 26, 28.

Each of the data elements 24, 26, 28 collected by the wearable device 20 is one of an environmental data element 24 containing a value associated with an environmental condition, or a user data element 26 containing a value associated with a user condition, or a feedback data element 28 containing a value regarding the wearer's job satisfaction. The feedback data elements 28 may be directly related to a specific task being performed. Alternatively or additionally, the feedback data elements 28 may be related to a more generic satisfaction, such as, for example, a current mood or happiness level of the wearer.

One or more environmental conditions may be monitored and recorded by the system 10 as the environmental data elements 24. Those environmental conditions may include, for example: light level, light type, sound level, air quality, temperature, and/or humidity. The light level and light type may indicate the brightness and the type of lighting, respectively, exposed to the wearable device 20.

One or more user conditions may be monitored and recorded by the system 10 as the user data elements 26. Those user conditions may include, for example: body temperature, heart rate, oxygen saturation, and/or blood pressure.

As illustrated in the example embodiment shown in the block diagram of FIG. 2, the wearable device 20 includes a first processor 30 coupled to a first machine-readable storage memory 32. The first machine-readable storage memory 32 may include one or more of a RAM memory, a ROM memory, flash, or DRAM and may include magnetic, optical, semiconductor, or another type of machine-readable storage.

The wearable device 20 also includes an output device 36 configured to present a prompt 38 to the wearer. The prompt 38 may directly request information from the wearer regarding job satisfaction. Alternatively or additionally, the prompt 38 may indicate that the wearer should take additional steps, such as viewing a screen, or reading or listening to additional directions. The prompt 34 may include an audio indicator, such as a beeping, buzzing, chime, tune, or a voice prompt, which may be provided by an output device 36 that includes an audio generator such as a speaker or buzzer. Alternatively or additionally, the prompt 34 may include a visual indicator, such as a light, a graphic indicator, and/or a textual indicator. Such a visual indicator may be provided by an output device 36 that includes a visual generator such as an electric light and/or a display screen. Alternatively or additionally, the prompt 34 may include a tactile indicator, such as a vibration, shaking, poking, etc., which may be provided by a hardware device such as a vibrator motor.

The wearable device 20 also includes an input device 40 configured to receive the feedback information regarding job satisfaction from the wearer. The output device 36 may be combined with the input device 40, for example, as a touch screen like the example shown on FIG. 3. The input device 40 may be configured to receive the feedback data 42 from the wearer as a numeric value. Alternatively or additionally, the input device 40 may be configured to receive the feedback data 42 from the wearer using a graphic indicator 76, such as for example, as a slider that can be set to any one of several positions between extreme ends. Another example is shown in FIG. 3, in which the graphic indicators 76 take the form of faces with different expressions that each correspond to a corresponding satisfaction level. Alternatively or additionally, the output device 36 may be configured to present one or more questions to the wearer and the input device 40 may then receive the feedback data 42 as answers to those questions.

The output device 36 may also includes a decline input 78 to allow the wearer to acknowledge the prompt 38 and to decline to provide the feedback data 42. The decline input 78 may take the form of a button or graphic indicator, such as the example shown in FIG. 3. The decline input 78 may also function as a “snooze” or as a delay, which causes the prompt 38 to re-appear after a predetermined period of time. Such functionality may be useful for a wearer that is busy with a particular task when the prompt 38 is first presented, but who may be free to respond at a later time.

The wearable device 20 may be configured to present the prompt 34 to the wearer at predetermined times. Alternatively or additionally, the wearable device 20 may be configured to present the prompt 34 to the wearer at random times. Alternatively or additionally, the wearable device 20 may be configured to present the prompt 34 to the wearer upon manual request or upon the happening of a predetermined condition.

As also shown in FIG. 2, the wearable device 20 includes a first communications interface 42 configured to transmit the data elements 24, 26, 28 to a server 50 via a network 44. The first communications interface 42 may include a wired or a wireless interface, such as, for example, a Universal Serial Bus (USB) or Ethernet interface, or a Wi-Fi, Zigbee, or cellular data radio. The network 44 may include one or more wired and/or wireless segments, which may include, for example, Wi-Fi, Zigbee, Ethernet, infrared, etc.

The wearable device 20 also includes first instructions 46 stored in the first machine-readable storage memory 32 for directing the first processor 26 to cause the user interface 34 to present the prompt 38 and to cause the first processor 30 to store the data elements 24, 26, 28 in a first data storage region 48 of the first storage memory 32 and to transmit the data elements 24, 26, 28 to the server 50. In other words, the first instructions 46 may include compiled or interpreted data instructions that cause the first processor 30 to perform operations to enable the system 10 to function.

The server 50 includes a second communications interface 54 for receiving the data 24, 26, 28 from the wearable device 20. The second communications interface 54 may include one or more wired and/or wireless interfaces, which may be the same type or a different type as the first communications interface 42. The server 50 also includes a second processor 56 and a second machine-readable storage memory 58 including a second data storage 60 for storing the data elements 24, 26, 28. The second machine-readable storage memory 58 also holding second instructions 62 for causing the second processor 56 to store and analyze the data elements 24, 26, 28 and to determine a job satisfaction score 64 and a correlation score 66 for the wearer. The server 50 may store the data elements 24, 26, 28 locally within the second data storage 60 of the second machine-readable storage memory 58. Additionally or alternatively, the server 50 may store the data elements 24, 26, 28 in another location, such as in another server 50 and/or in a database and/or in a network attached storage (NAS) device.

The job satisfaction score 64 is based upon the feedback data elements 28 and may be influenced by several of the feedback data elements 28, such as a running average. The job satisfaction score 64 may be based upon the feedback data elements 28 from two or more different users, who may each have their own wearable device 20. The job satisfaction score 64 may take into account other factors such as the time of day, the shift, the wearer's productivity, and/or the specific type of work being performed by the wearer when the feedback data elements 28 are collected.

The correlation score 66 indicates a correlation between the feedback data elements 28 and one or more of the environmental data elements 24 and/or the user data elements 26. One or more different correlation scores 66 may be helpful to management for identifying conditions that have a disproportionate effect on job satisfaction. Such information may be used, for example, to budgeting and/or to schedule changes to the workplace that are likely to result in the largest improvements in the worker's job satisfaction. For example, a correlation score that indicates relatively low worker satisfaction for wearers who are regularly illuminated by certain types of lighting may prompt management to upgrade and replace that lighting. In another example, decisions regarding temperature settings and/or heating ventilation, and air conditioning (HVAC) ducting may be informed by correlation data showing how temperature and air quality impacts the worker's job satisfaction.

A reporting interface 70 is provided in communication with the server 50 and is configured to report the job satisfaction score 64 and the correlation score 66. The reporting interface 70 may present a report that correlates the feedback data 42 with one or more of the environmental data 24 and/or the user data 26 and/or with other data regarding the job or the wearer, such as, for example, the job type, time of day, time worked that shift, consecutive days worked, deadlines, etc.

The reporting interface 70 may take one or more forms including a program or application running on a computer or mobile device, a website interface, an electronically-generated report formatted for printed publication, and/or a display screen, such as the type used to display information on a shop or factory floor. The job satisfaction score 64 and/or the correlation score 66 may be formatted for widespread dissemination. For example, they may be anonymized and/or aggregated over several wearers and/or over a period of time (i.e. by shift, by day, or week). The job satisfaction score 64 and/or the correlation score 66 may be provided as notifications sent to a mobile device and/or the wearable device 20 itself.

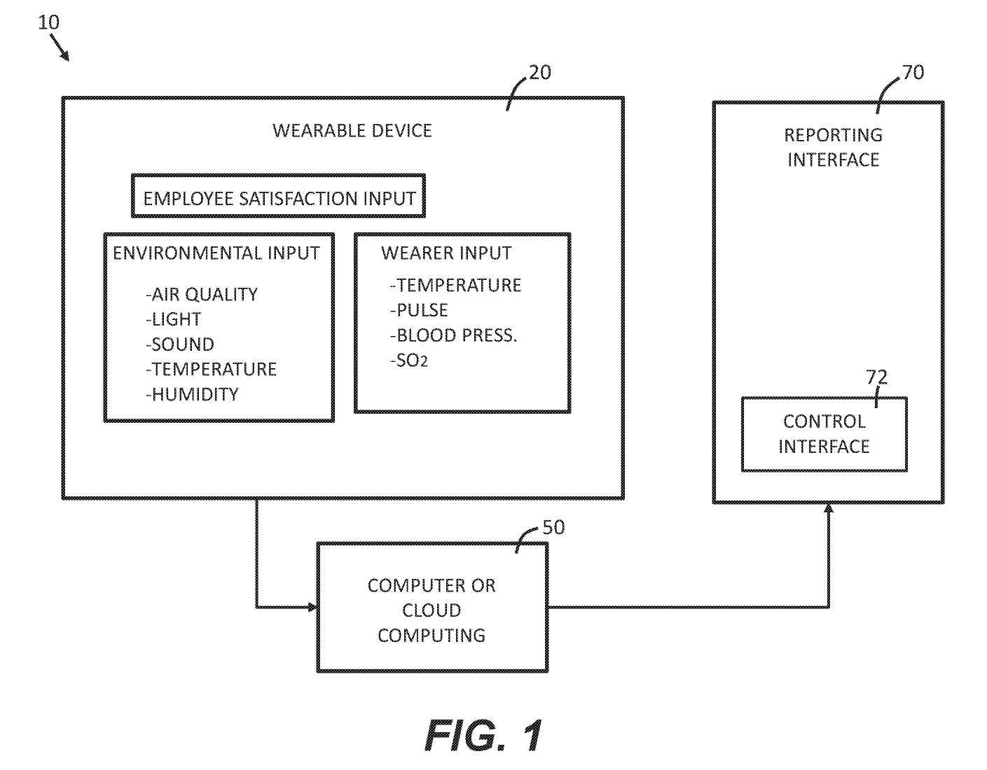

The system 10 also includes a control interface 72 for allowing an administrator to control various settings related to the operation of the system 10. The control interface 72 may be with the reporting interface 70 as shown in the example of FIG. 1, particularly where the reporting interface 70 has limited access and input capabilities, such as, for example, where the reporting interface 70 takes the form of a computer program of web-based interface. The control interface 72 may, for example, allow the administrator to manually initiate one or more wearable devices 20 to provide prompts 38 to the associated wearers. Alternatively or additionally, the control interface 72 may, for example, allow the administrator to set the predetermined conditions that cause the wearable devices 20 to provide prompts 38 to the associated wearers.

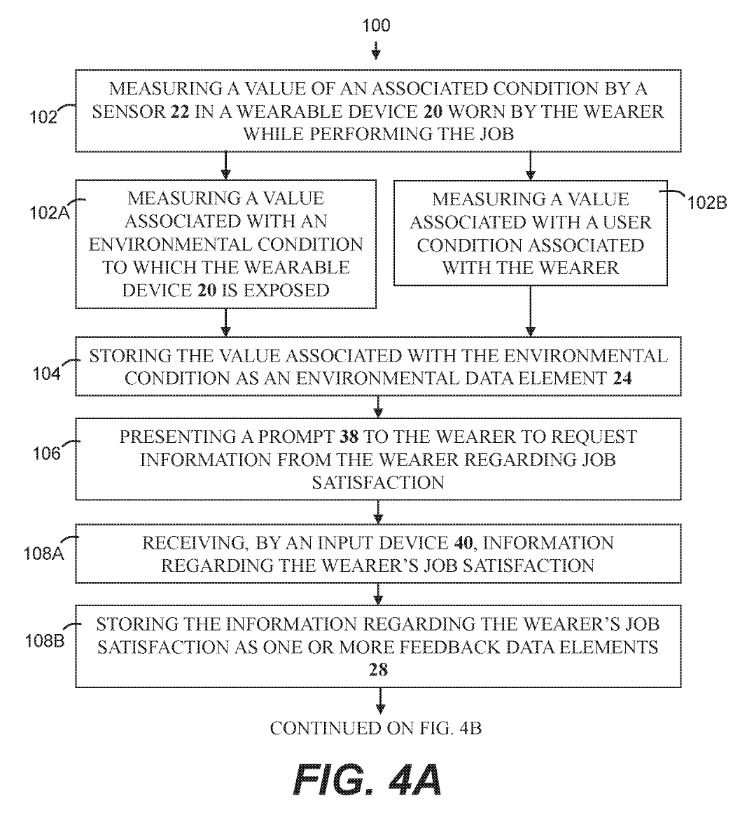

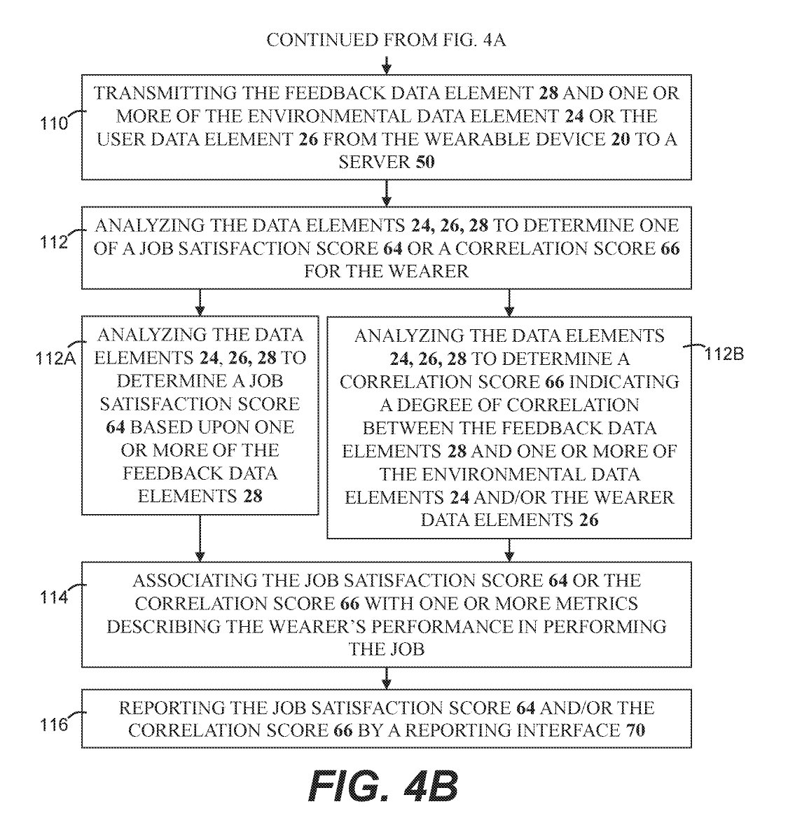

As described in the flow charts of FIGS. 4A-4B, a method 100 of gathering and displaying data related to a wearer's satisfaction in performing a job is also provided.

The method 100 includes 102 measuring a value of an associated condition by a sensor 22 in a wearable device 20 worn by the wearer while performing the job.

The step of 102 measuring a value of an associated condition by a sensor 22 may further include: 102A measuring a value associated with an environmental condition to which the wearable device 20 is exposed. The environmental condition may include one or more of: light level, light type, sound level, air quality, temperature, and/or humidity.

The step of 102 measuring a value of an associated condition by a sensor 22 may further include: 102B measuring a value associated with a user condition associated with the wearer. The user condition may include one or more of: body temperature, heart rate, oxygen saturation, and/or blood pressure.

The method 100 also includes 104 storing the value of the associated condition measured by the sensor 22 as one of an environmental data element 24 or a user data element 26. Where the associated condition relates to the ambient environment, its value would be stored as an environmental data element 24. Similarly, where the associated condition relates to the wearer, its value would be stored as a user data element 26.

The method 100 also includes 106 presenting a prompt 38 to the wearer to request information from the wearer regarding job satisfaction. As described above, the prompt 38 may take one or more different forms including a visual, audio, and/or a tactile prompt.

The method 100 also includes 108A receiving, by an input device 40, information regarding the wearer's job satisfaction, and 108B storing the information regarding the wearer's job satisfaction as one or more feedback data elements 28. These steps are preferably performed in tandem by the wearable device 20. As described above, the information may regarding the wearer's job satisfaction may take one or more different forms including numeric data or as a selection from graphical representations of several different emotional states.

The method 100 also includes 110 transmitting the feedback data element 28 and one or more of the environmental data element 24 or the user data element 26 from the wearable device 20 to a server 50. The exact data elements 24, 26, 28 that are transmitted to the server 50 may depend on the type of information that is collected.

The method 100 also includes 112 analyzing the data elements 24, 26, 28 to determine one of a job satisfaction score 64 or a correlation score 66 for the wearer.

The step of analyzing the data elements 24, 26, 28 to determine one of a job satisfaction score 64 or a correlation score 66 for the wearer may include 112A analyzing the data elements 24, 26, 28 to determine a job satisfaction score 64 which is based upon one or more of the feedback data elements 28.

Alternatively or additionally, the step of analyzing the data elements 24, 26, 28 to determine one of a job satisfaction score 64 or a correlation score 66 for the wearer may include 112B analyzing the data elements 24, 26, 28 to determine a correlation score 66 indicating a degree of correlation between the feedback data elements 28 and one or more of the environmental data elements 24 and/or the user data elements 26.

The method 100 may also include 114 associating the job satisfaction score 64 or the correlation score 66 with one or more metrics describing the wearer's performance in performing the job. For example, a wearer who is actively performing their assigned job duties may be given a greater weight when determining the job satisfaction score 64 and/or the correlation score 66. Similarly, a wearer that is less productive, or one that is not currently productive, such as a worker that is on a lunch break, may have reduced or zero weight in the determination of the job satisfaction score 64 and/or the correlation score 66.

The method 100 also includes 116 reporting the job satisfaction score 64 and/or the correlation score 66 by a reporting interface 70. Details regarding different embodiments of the reporting interface 70 and their operation are described above.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for gathering and displaying data related to a wearer's satisfaction in performing a job and comprising:
a wearable device to be worn by the wearer while performing the job, and including a sensor configured to measure an associated condition, and with said wearable device configured to store a plurality of data elements each containing a value associated with said associated condition at a given time,
each of said data elements being one of an environmental data element with said value being associated with an environmental condition, or a user data element with said value being associated with a user condition, or a feedback data element with said value being associated with the wearer's job satisfaction;
said wearable device including an output device configured to present a prompt to the wearer requesting specific information from the wearer, and said wearable device including an input device configured to receive said value regarding the wearer's job satisfaction;
said wearable device including a first communications interface configured to transmit said data elements to a server, with said server configured to store and analyze said data elements and to determine one of a job satisfaction score or a correlation score for the wearer, with said job satisfaction score based upon said feedback data elements, and with said correlation score indicating a degree of correlation between said feedback data elements and one or more of said environmental data elements and said user data elements;
a reporting interface in communication with said server and configured to report said one of said job satisfaction score or said correlation score.

2. The system of claim 1, wherein said data elements include an environmental data element containing a value associated with an environmental condition; and
wherein said environmental condition is selected from a group comprising: light level, light type, sound level, air quality, temperature, and humidity.

3. The system of claim 1, wherein said data elements include a user data element containing a value associated with a user condition; and
wherein said user condition is selected from a group comprising: body temperature, heart rate, oxygen saturation, and blood pressure.

4. The system of claim 1, wherein said wearable device is configured to present said prompt to the wearer at predetermined times.

5. The system of claim 1, wherein said wearable device is configured to present said prompt to the wearer at random times.

6. The system of claim 1, wherein said wearable device is configured to present said prompt to the wearer upon manual request or upon the happening of a predetermined condition.

7. The system 10 of claim 1, wherein said prompt includes an audio indicator.

8. The system of claim 1, wherein said prompt includes a visual indicator.

9. The system 10 of claim 1, wherein said prompt includes a tactile indicator.

10. The system of claim 1, wherein input device of said user interface is configured to receive said feedback data from the wearer as a numeric value.

11. The system of claim 1, wherein input device of said user interface is configured to receive said feedback data from the wearer using a graphic indicator.

12. The system of claim 1, wherein said output device is configured to present one or more questions to the wearer and wherein said input device is configured to receive said feedback data as answers to the one or more questions.

13. The system of claim 1, wherein input device includes a decline input to allow the wearer to acknowledge said prompt and to decline to provide said feedback data.

14. The system of claim 1, wherein said reporting interface presents a report correlating said feedback data with one or more of said environmental data or said user data or other data regarding the job or the wearer.

15. A method of gathering and displaying data related to a wearer's satisfaction in performing a job and comprising:
measuring a value of an associated condition by a sensor in a wearable device worn by the wearer while performing the job;
storing the value of the associated condition measured by the sensor as one of an environmental data element or a user data element;
presenting a prompt to the wearer to request information from the wearer regarding job satisfaction;
receiving, by an input device, information regarding the wearer's job satisfaction, and storing the information regarding the wearer's job satisfaction as one or more feedback data elements;
transmitting the feedback data element and one or more of the environmental data element or the user data element from the wearable device to a server;
analyzing the data elements to determine one of a job satisfaction score or a correlation score for the wearer; and
reporting the one of the job satisfaction score or the correlation score by a reporting interface.

16. The method of claim 15, wherein the step of measuring a value of an associated condition by a sensor further includes:
measuring a value associated with an environmental condition to which the wearable device is exposed;
wherein the step of storing the value of the associated condition measured by the sensor as one of an environmental data element or a user data element includes storing the value associated with the environmental condition as the environmental data element; and
wherein the environmental condition is selected from a group comprising: light level, light type, sound level, air quality, temperature, and humidity.

17. The method of claim 15, wherein the step of measuring a value of an associated condition by a sensor further includes:
measuring a value associated with a user condition associated with the wearer;
wherein the step of storing the value of the associated condition measured by the sensor as one of an environmental data element or a user data element includes storing the value associated with the user condition as a user data element; and
wherein said user condition is selected from a group comprising: body temperature, heart rate, oxygen saturation, and blood pressure.

18. The method of claim 15, wherein the step of analyzing the data elements to determine one of a job satisfaction score or a correlation score for the wearer further includes analyzing the data elements to determine a job satisfaction score; and
wherein the job satisfaction score is based upon one or more of the feedback data elements.

19. The method of claim 15, wherein the step of analyzing the data elements to determine one of a job satisfaction score or a correlation score for the wearer further includes analyzing the data elements to determine a correlation score; and
wherein the correlation score indicates a degree of correlation between the feedback data elements and one or more of the environmental data elements or the user data elements.

20. The method of claim 15, further including the step of associating the one of the job satisfaction score or the correlation score with one or more metrics describing the wearer's performance in performing the job.
